(19) United States
(12) Patent Application Publication
(10) Pub. No.: US 2022/0258481 A1
(43) Pub. Date: Aug. 18, 2022

(54) PRINTING APPARATUS

(71) Applicant: Seiko Epson Corporation, Tokyo (JP)

(72) Inventor: Noriyuki TAKAHASHI, Shiojiri-shi (JP)

(21) Appl. No.: 17/650,953

(22) Filed: Feb. 14, 2022

(30) Foreign Application Priority Data
Feb. 17, 2021 (JP) 2021-023172

(51) Int. Cl. B41J 2/175; B41J 2/21

(52) U.S. Cl. CPC B41J 2/17533; B41J 2/2103

(57) ABSTRACT

A printing apparatus including a first head configured to eject a first ink, a second head that ejects a second ink different from the first ink, a carriage that reciprocates while holding the first head and the second head, a first storage unit that stores the first ink, a second storage unit that stores the second ink, a first flow path that couples the first storage unit and the first head, and a second flow path that couples the second storage unit and the second head, wherein the first flow path is shorter than the second flow path and the first storage unit is disposed at the carriage and the second storage unit is disposed at a different position from that of the carriage.

The present application is based on, and claims priority from JP Application Serial Number 2021-023172, filed Feb. 17, 2021, the disclosure of which is hereby incorporated by reference herein in its entirety.

### BACKGROUND

### 1. Technical Field

The present disclosure relates to a printing apparatus.

### 2. Related Art

Printing apparatuses that print on media using various inks have been used. In such printing apparatuses, special inks may be used, such as, for example, inks using color materials that are highly sedimentable or inks containing high-cost components. For example, JP-A-2016-64558 discloses a printing apparatus that uses a white ink containing titanium oxide or the like, which is a highly sedimentable color material, along with a black ink, a cyan ink, a magenta ink, and a yellow ink that form an image.

The printing apparatus of JP-A-2016-64558 uses a white ink in which a color material is highly sedimentable, and thus, the printing apparatus has a circulation path capable of circulating the white ink to suppress a problem due to sedimentation of a color material in the white ink. Consequently, in the printing apparatus of JP-A-2016-64558, the size, complexity, and cost of the printing apparatus is increased. Note that, in a known printing apparatus that uses an ink containing a highly sedimentable component and that does not have a circulation path, an ink in an ink flow path is periodically discharged as part of a maintenance operation to suppress use of the ink in which specific components have been sedimented. Additionally, even in a printing apparatus that uses an ink containing no highly sedimentable component, the ink may be discharged during maintenance or the like, and when an ink containing a high-cost component is used, it is desirable to reduce a consumption amount of the ink as much as possible. Accordingly, a printing apparatus that has a simple configuration and that can reduce a consumption amount of specific inks, such as inks containing highly sedimentable components and expensive inks is desired.

### SUMMARY

To solve the above-described problems, a printing apparatus according to an aspect of the present disclosure includes a first head configured to eject a first ink, a second head configured to eject a second ink different from the first ink, a carriage configured to reciprocate while holding the first head and the second head, a first storage unit configured to store the first ink, a second storage unit configured to store the second ink, a first flow path configured to couple the first storage unit and the first head, and a second flow path configures to couple the second storage unit and the second head, wherein the first flow path is shorter than the second flow path and the first storage unit is disposed at the carriage and the second storage unit is disposed at a different position from that of the carriage.

### BRIEF DESCRIPTION OF THE DRAWINGS

FIG. 1 is a schematic view of a printing apparatus according to Example 1 of the present disclosure.

FIG. 2 is a schematic view illustrating a periphery of a carriage of the printing apparatus according to Example 1 of the present disclosure.

FIG. 3 is a schematic view viewing the periphery of the carriage of the printing apparatus according to Example 1 of the present disclosure in an angle different from that of FIG. 2.

FIG. 4 is a schematic view illustrating a state in which a first storage unit is detached from the carriage of the printing apparatus according to Example 1 of the present disclosure.

FIG. 5 is a schematic view illustrating a state in which the first storage unit and a first head are detached from the carriage of the printing apparatus according to Example 1 of the present disclosure.

FIG. 6 is a schematic view illustrating a state in which, instead of the first storage unit, a third storage unit is mounted to the carriage of the printing apparatus according to Example 1 of the present disclosure.

FIG. 7 is a schematic view illustrating a periphery of a carriage of a printing apparatus according to Example 2 of the present disclosure.

### DESCRIPTION OF EXEMPLARY EMBODIMENTS

To begin with, the present disclosure will be schematically described.

To solve the above-described problems, a printing apparatus according to a first aspect of the present disclosure includes a first head configured to eject a first ink, a second head configured to eject a second ink different from the first ink, a carriage configured to reciprocate while holding the first head and the second head, a first storage unit configured to store the first ink, a second storage unit configured to store the second ink, a first flow path configured to couple the first storage unit and the first head, and a second flow path configured to couple the second storage unit and the second head, wherein the first flow path is shorter than the second flow path and the first storage unit is disposed at the carriage and the second storage unit is disposed at a different position from that of the carriage.

According to the aspect, by disposing the first ink as a specific ink at the carriage, the first flow path can be made short, and a discharge amount of the first ink in the first flow path associated with maintenance can be reduced. Additionally, by disposing the first storage unit at the carriage, the first ink in the first storage unit can be agitated along with reciprocation of the carriage, and sedimentation or the like of a component of the first ink can be suppressed without providing a circulation path or the like. Thus, a consumption amount of the first ink can be reduced with the printing apparatus having a simple configuration.

According to a printing apparatus according to a second aspect of the present disclosure, in the first aspect, a color material contained in the first ink is more sedimentable than a color material contained in the second ink.

According to the aspect, the color material contained in the first ink is more sedimentable than the color material contained in the second ink. That is, sedimentation of the color material contained in the first ink that is highly sedimentable can be effectively suppressed in a simple configuration.

According to a printing apparatus according to a third aspect of the present disclosure, in the first or second aspect, capacity of the first storage unit is smaller than capacity of the second storage unit.

According to the aspect, the capacity of the first storage unit is smaller than the capacity of the second storage unit. Accordingly, the first storage unit disposed at the carriage can be made light, and load associated with reciprocation of the carriage can be reduced. When the load associated with the reciprocation of the carriage can be reduced, power consumption can be reduced, and a low-cost motor or the like can be used as a drive source of the carriage.

According to a printing apparatus according to a fourth aspect of the present disclosure, in any one of the first to third aspects, the first storage unit is attachable to and detachable from the carriage.

According to the present aspect, the first storage unit is attachable to and detachable from the carriage. Thus, refilling the first storage unit with the first ink and replacing a used first storage unit with a new first storage unit can be easily performed.

According to a printing apparatus according to a fifth aspect of the present disclosure, in the fourth aspect, the first storage unit is attachable to and detachable from the carriage together with the first head.

According to the aspect, the first storage unit is attachable to and detachable from the carriage together with the first head. Thus, replacing a used first head with a new first head can be easily performed.

According to a printing apparatus according to a sixth aspect of the present disclosure, in the fourth or fifth aspect, the printing apparatus is configured to perform printing operation by the second head using the second ink with the first storage unit detached from the carriage.

According to the aspect, the printing apparatus is configured to perform printing operation by the second head using the second ink with the first storage unit detached from the carriage. That is, an image can be formed using only the second ink. Thus, depending on a medium or the like to be used, an ink to be used can be selected to perform printing operation that may be performed. Further, when an image is formed using only the second ink, consumption of the first ink can be suppressed. This is because, when the first storage unit is detached from the carriage, consumption of the first ink during maintenance operation or the like can be suppressed.

According to a printing apparatus according to a seventh aspect of the present disclosure, in any one of the fourth to sixth aspects, instead of the first storage unit, a third storage unit configured to store a liquid different from the first ink is attachable to and detachable from the carriage.

According to the aspect, instead of the first storage unit, a third storage unit configured to store a liquid different from the first ink is attachable to and detachable from the carriage. Thus, for example, by containing a maintenance ink in the third storage unit, a maintenance operation can be easily performed. Additionally, for example, by containing an image forming ink in the third storage unit, an image can be formed with higher accuracy.

Exemplary embodiments according to the present disclosure will now be described specifically with reference to the accompanying drawings.

### Example 1

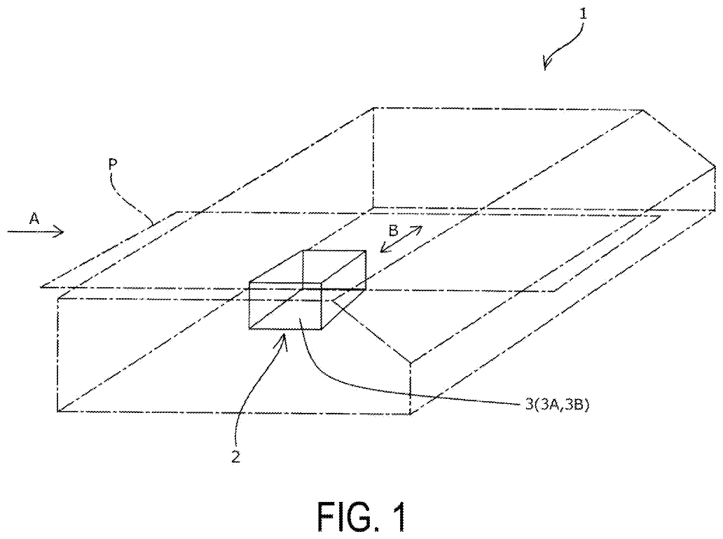

First, an overview of a printing apparatus 1 according to Example 1 of the present disclosure will be described with reference to FIG. 1. The printing apparatus 1 according to the example prints by reciprocating a carriage 2, which is provided, on a side facing a medium P, with a head 3 that ejects an ink, in a scanning direction B that intersects with a transport direction A with respect to the medium P that is being transported in the transport direction A by a transport unit (not illustrated). Specifically, the head 3 is reciprocated in the scanning direction B via the carriage 2 while the medium P is intermittently driven in the transport direction A and the ink is ejected from the head 3 to print.

The printing apparatus 1 according to the example also has a configuration to print with respect to the medium P such as a T-shirt supported on a holder (not illustrated) while transporting the holder in the transport direction A. However, the printing apparatus 1 according to the present disclosure is not limited to such a configuration. For example, the printing apparatus 1 according to the present disclosure may have a configuration to print in which a platen is provided at a position facing the head 3 and the medium P, for example, a single sheet-shaped medium such as cut paper or an elongated medium such as roll paper is supported on the platen and transported with a roller pair or the like while printing. In other words, the configuration, shape, size, and the like of the printing apparatus 1 are not particularly limited.

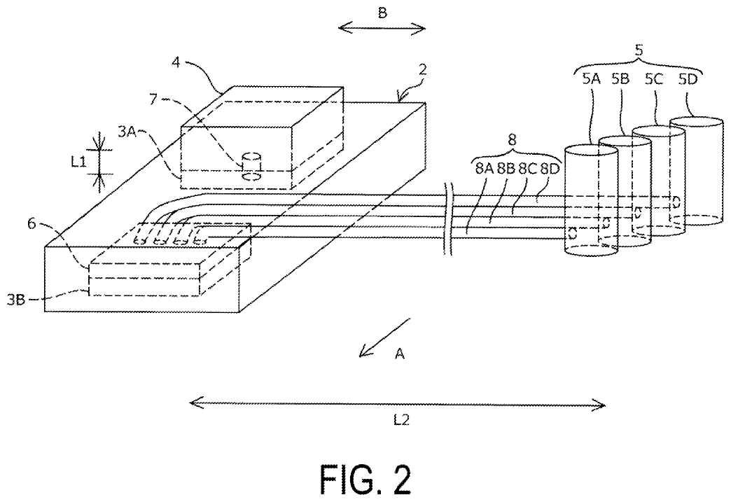

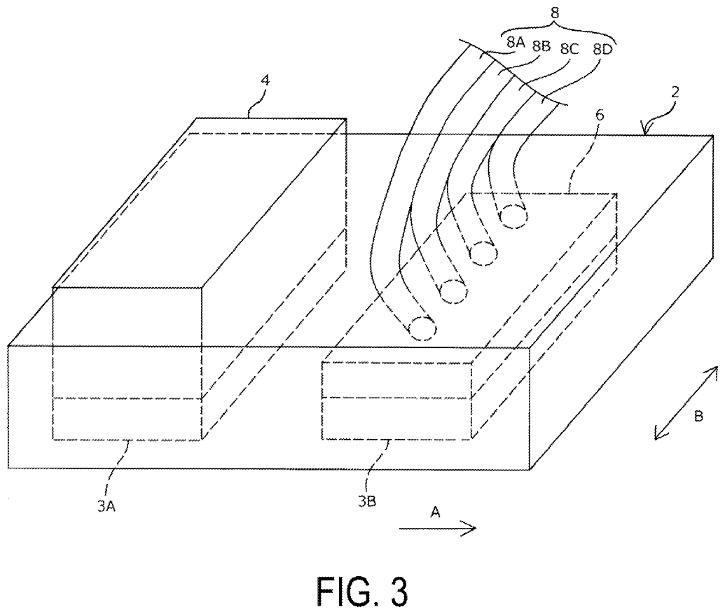

Next, the carriage 2 in the printing apparatus 1 according to the example as well as the details of the head 3 mounted on the carriage 2 and the ink used in the head 3 will be described with reference to FIGS. 2 to 6. As illustrated in FIGS. 2 and 3, and the like, the carriage 2 of the printing apparatus 1 according to the example includes, as the head 3, a first head 3A and a second head 3B.

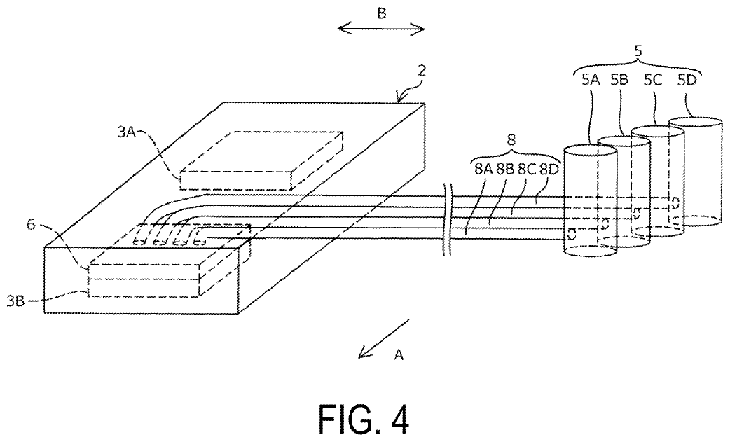

As illustrated in FIGS. 2 and 3, and the like, a first storage unit 4 containing a white ink as a first ink that can be used when performing printing or the like on the medium P such as a T-shirt is attached to a top portion of the first head 3A. The white ink can be used, for example, to form a white undercoat prior to forming an image with respect to the medium P such as a dark-colored T-shirt. Here, as illustrated in FIG. 4, the printing apparatus 1 according to the example has a configuration in which the first storage unit 4 can be detached from the first head 3A. Further, the configuration is such that the first storage unit 4 is mounted at the first head 3A and the white ink is introduced into a nozzle (not illustrated) of the first head 3A via a first flow path 7 illustrated in FIG. 2, and thus, a desired negative pressure can be applied at the nozzle.

On the other hand, as illustrated in FIG. 2 and the like, a negative pressure adjustment unit 6 provided with a self-sealing valve is provided at a top portion of the second head 3B so that desired negative pressure can be applied at a nozzle (not illustrated) of the second head 3B. Then, as illustrated in FIG. 2 and the like, second flow paths 8 coupled to second storage units 5 containing color inks are coupled to the negative pressure adjustment unit 6. Specifically, the second storage units 5 include a black ink storage unit 5A containing a black ink, a cyan ink storage unit 5B containing a cyan ink, a magenta ink storage unit 5C containing a magenta ink, and a yellow ink storage unit 5D containing a yellow ink. The second flow paths 8 include a black ink flow path 8A coupled to the black ink storage unit 5A, a cyan ink flow path 8B coupled to the cyan ink storage unit 5B, a magenta ink flow path 8C coupled to the magenta ink storage unit 5C, and a yellow ink flow path 8D coupled to the yellow ink storage unit 5D.

The printing apparatus 1 according to the example can form a desired image with the black ink, the cyan ink, the magenta ink, and the yellow ink using the second head 3B at the medium P, on which the undercoat has been formed with the white ink using the first head 3A. Note that, in the printing apparatus 1 according to the example, each of the second storage units 5 is configured to be attachable to and detachable from the respective second flow paths 8, however, the second storage unit 5 may be configured such that the second storage unit 5 is fixed with respect to the second flow path 8 in an undetachable manner and can be refilled with a desired ink. Additionally, in the example, the first head 3A is disposed upstream in the transport direction A, and the second head 3B is disposed downstream in the transport direction A, however, the second head 3B may be disposed upstream in the transport direction A, and the first head 3A may be disposed downstream in the transport direction A. Further, the number of heads 3 to be disposed is not limited to two, and three or more heads 3 may be disposed along the transport direction A. In this case, a storage unit in which an ink is stored is attached to a top portion of at least one head 3, a negative pressure adjustment unit provided with a self-sealing valve is provided at a top portion of at least one head 3, the negative pressure adjustment unit is configured to be coupled to a flow path coupled to a storage unit in which the color ink is contained, and a remaining head 3 has a top portion at which a storage unit may be attached or a negative pressure adjustment unit provided with a self-sealing valve may be provided.

Here, in summary, the printing apparatus 1 according to the example includes a first head 3A that ejects a first ink and a second head 3B that ejects a second ink different from the first ink. Additionally, the printing apparatus 1 according to the example includes a carriage 2 that reciprocates in the scanning direction B while holding the first head 3A and the second head 3B. Additionally, the printing apparatus 1 according to the example includes a first storage unit 4 that stores the first ink, a second storage unit 5 that stores the second ink, a first flow path 7 that couples the first storage unit 4 and the first head 3A, and a second flow path 8 that couples the second storage unit 5 and the second head 3B.

Here, the first flow path 7 that couples the first storage unit 4 and the first head 3A is configured to couple the first storage unit 4 and the first head 3A with the first storage unit 4 being placed on the first head 3A that is to be mounted on the same carriage 2. Thus, a length L1 of the first flow path 7 is very short. On the other hand, the second storage unit 5 is disposed at a position different from that of the carriage 2, and a length L2 of the second flow path 8 is long because the length is required to allow reciprocation of the carriage 2 in the scanning direction B. That is, in the printing apparatus 1 according to the example, the first flow path 7 is shorter than the second flow path 8, the first storage unit 4 is disposed at the carriage 2, and the second storage unit 5 is disposed at a position different from that of the carriage 2.

As described above, the printing apparatus 1 according to the example enables a discharge amount of the first ink in the first flow path 7 associated with maintenance to be reduced by disposing the first ink as a white ink, which is a specific ink, at the carriage 2 to make the first flow path 7 short. Additionally, in the printing apparatus 1 according to the example, titanium oxide having high specific gravity and being highly sedimentable is used as a color material, however, by disposing the first storage unit 4 at the carriage 2, the first ink in the first storage unit 4 can be agitated along with reciprocation of the carriage 2, and sedimentation or the like of titanium oxide, which is a component of the first ink, is suppressed without providing a circulation path or the like. Thus, by configuring a printing apparatus as the example or the like, a consumption amount of the first ink can be reduced while the printing apparatus 1 has a simple configuration.

In the printing apparatus 1 according to the example, lengths of the black ink flow path 8A, the cyan ink flow path 8B, the magenta ink flow path 8C, and the yellow ink flow path 8D, which are each of second flow paths 8, are substantially equal.

Note that, as described above, in the printing apparatus 1 according to the example, a white ink as the first ink uses titanium oxide that is highly sedimentable as a color material. On the other hand, a commonly used pigment is used as a color material for each color ink as the second ink. That is, the color material contained in the first ink is more sedimentable than the color material contained in the second ink.

Thus, in the printing apparatus 1 according to the example, the color material contained in the first ink is more sedimentable than the color material contained in the second ink. However, by configuring the first flow path 7 to be shorter than that of the second flow path 8 and disposing the first storage unit 4 at the carriage 2, sedimentation of the color material contained in the first ink that is highly sedimentable can be effectively suppressed in a simple configuration. Note that “the color material contained in the first ink is more sedimentable than the color material contained in the second ink” means that the color material contained in the first ink has higher specific gravity than that of the color material contained in the second ink, as well as that, even when the color material contained in the first ink does not have higher specific gravity than that of the color material contained in the second ink, a solvent contained in the first ink has lower specific gravity than that of a solvent contained in the second ink, and the color material contained in the first ink is relatively more sedimentable than the color material contained in the second ink.

Here, in the printing apparatus 1 according to the example, capacity of each of the second storage units 5 is the same, and capacity of the first storage unit 4 is smaller than capacity of the second storage units 5. By configuring the capacity of the first storage unit 4 to be smaller than the capacity of the second storage unit 5 in this manner, the first storage unit 4 disposed at the carriage 2 can be configured to be light, and load associated with reciprocation of the carriage 2 can be reduced. When the load associated with the reciprocation of the carriage 2 can be reduced, power consumption can be reduced, and a low-cost motor or the like can be used as a drive source of the carriage 2. In the example, capacity of each of the second storage units 5 is the same, however, they may each have different capacities. In this case, the capacity of the first storage unit 4 may be smaller than the capacity of each of all of the second stored units 5, however, the capacity of the first storage unit 4 suffices to be smaller than the capacity of at least one second storage unit 5.

In addition, as illustrated in FIG. 4, in the printing apparatus 1 according to the example, the first storage unit 4 can be detached from the carriage 2. Thus, in the printing apparatus 1 according to the example, the first storage unit 4 can be attachable to and detachable from the carriage 2. Consequently, in the printing apparatus 1 according to the example, refilling the first storage unit 4 with the first ink and replacing a used first storage unit 4 with a new first storage unit 4 can be easily performed. An example of the first storage unit 4 includes an ink cartridge.

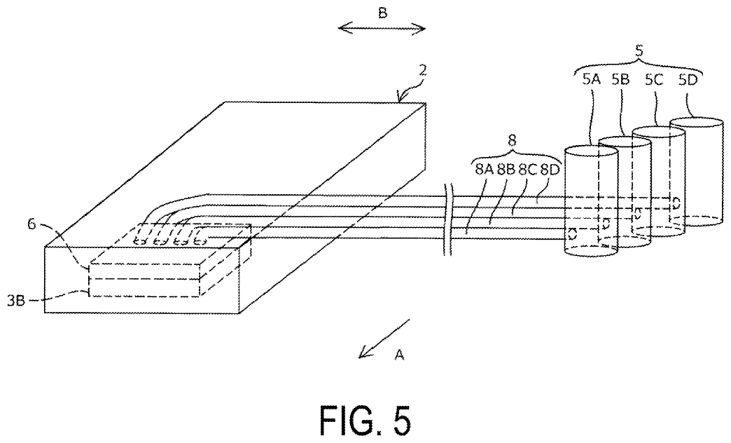

Further, as illustrated in FIG. 5, in the printing apparatus 1 according to the example, the first head 3A can be detached from the carriage 2. In other words, in the printing apparatus 1 according to the example, the first storage unit 4 is attachable to and detachable from the carriage 2 together with the first head 3A. Thus, replacing a used first head 3A with a new first head 3A can be easily performed. Note that “the first storage unit 4 is attachable to and detachable from the carriage 2 together with the first head 3A” means to include a configuration in which the first storage unit 4 is detachable from the first head 3A as in the printing apparatus 1 according to the example, as well as a configuration in which the first storage unit 4 and the first head 3A are integral with each other as in a printing apparatus 1 according to Example 2 described below. In the case of a configuration in which the first storage unit 4 is detachable from the first head 3A as in the printing apparatus 1 according to the example, only the first head 3A can be replaced when the first ink remains in the first storage unit 4 and the first storage unit 4 that being used until then can be used again.

In addition, in the printing apparatus 1 according to the example, printing operation can be performed by the second head 3B using the second ink contained in the second storage unit 5 with the first storage unit 4 being detached from the carriage 2 as illustrated in FIGS. 4 and 5. That is, an image can be formed with using only the color ink which is the second ink without using the white ink which is the first ink. Thus, in the printing apparatus 1 according to the example, depending on a type of the medium P or the like to be used, an ink to be used can be selected to perform printing operation that may be performed. Further, the printing apparatus 1 according to the example having such a configuration enables when an image is formed using only the second ink, consumption of the first ink to be suppressed. This is because, when the first storage unit 4 is detached from the carriage 2, consumption of the first ink during maintenance operation or the like can be suppressed.

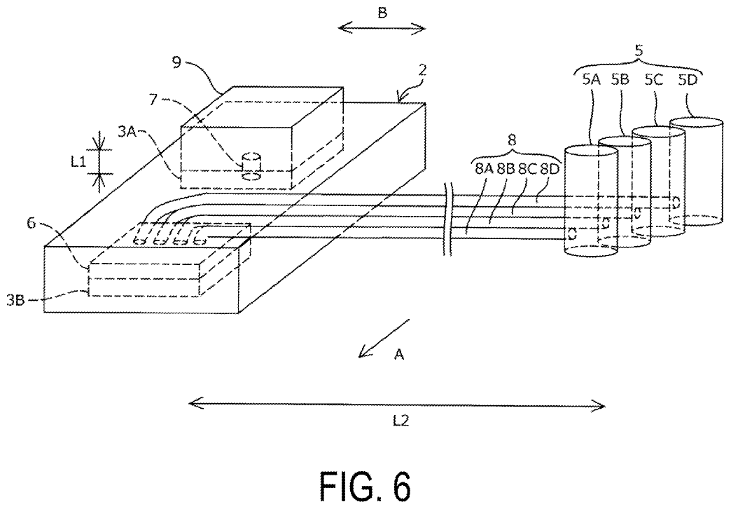

Further, as illustrated in FIG. 6, in the printing apparatus 1 according to the example, instead of the first storage unit 4, a third storage unit 9 that stores a liquid different from the first ink is attachable to and detachable from the carriage 2. Thus, for example, by containing a maintenance ink in the third storage unit 9, a maintenance operation can be easily performed. Additionally, for example, by containing an image forming ink different from the second ink, such as an ink having a different color than the second ink, in the third storage unit 9, an image can be formed with higher accuracy. Note that examples of the ink having a different color from the second ink include, but are not limited to, a silver ink, an orange ink, a green ink, a blue ink, a gray ink, a light cyan ink, a light magenta ink, or the like. Further, as the ink to be stored in the third storage unit 9, a pretreatment liquid that is to be applied to the medium P prior to ejecting the ink containing the color material onto the medium P or a post-treatment liquid that is to be applied to the medium P after ejecting the ink containing the color material onto the medium P may be stored. The pretreatment liquid and the post-treatment liquid include reaction liquids and coating agents, for example.

### Example 2

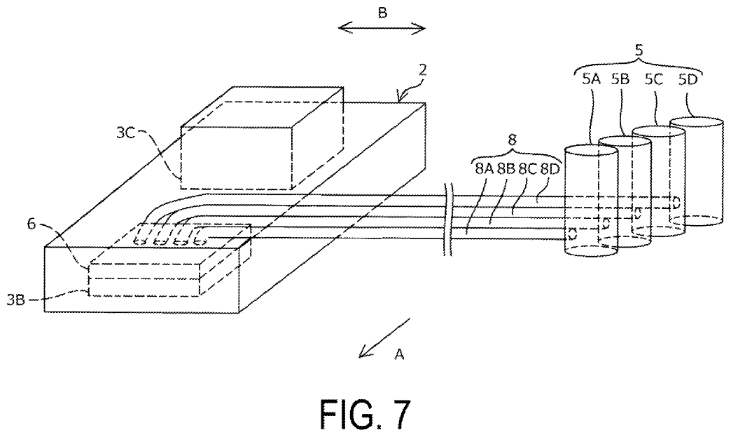

Next, a printing apparatus 1 according to Example 2 will be described by use of FIG. 7. Note that FIG. 7 is a diagram corresponding to FIG. 2 in the printing apparatus 1 according to Example 1. In FIG. 7, the constituent members common to those in Example 1 described above are denoted by the same reference numerals, and the detailed description will be omitted. Here, the printing apparatus 1 according to the example has a shape similar to that of the printing apparatus 1 according to Example 1 except for its configuration of the carriage 2. Thus, for a portion other than that is described below, the printing apparatus 1 according to the example includes similar features as the printing apparatus 1 according to Example 1.

As described above, the printing apparatus 1 according to Example 1 is configured so that the first storage unit 4 is detachable from the first head 3A, as illustrated in FIG. 2 and the like. On the other hand, as illustrated in FIG. 7, the printing apparatus 1 according to the example has a head cartridge 3C in which the first storage unit and the first head are integrally configured. By configuring the first storage unit and the first head integrally, as in the printing apparatus 1 according to the example, air bubbles can be suppressed from entering, for example, the flow path between the first ink containing unit and the nozzle for ejecting the first ink that corresponds to the first flow path, and the ejecting failure of the ink and the like can be suppressed.

The present disclosure is not limited to the examples described above, and can be realized in various configurations without departing from the spirit of the present disclosure. For example, appropriate replacements or combinations may be made to the technical features in the examples which correspond to the technical features in the aspects described in the SUMMARY section to solve some or all of the problems described above or to achieve some or all of the advantageous effects described above. Additionally, when the technical features are not described herein as essential technical features, such technical features may be deleted appropriately.

What is claimed is:

1. A printing apparatus comprising:
a first head configured to eject a first ink;
a second head configured to eject a second ink different from the first ink;
a carriage configured to reciprocate while holding the first head and the second head;
a first storage unit configured to store the first ink;
a second storage unit configured to store the second ink;
a first flow path configured to couple the first storage unit and the first head; and
a second flow path configured to couple the second storage unit and the second head; wherein
the first flow path is shorter than the second flow path and
the first storage unit is disposed at the carriage and the second storage unit is disposed at a different position from that of the carriage.

2. The printing apparatus according to claim 1, wherein
a color material contained in the first ink is more sedimentable than a color material contained in the second ink.

3. The printing apparatus according to claim 1, wherein
capacity of the first storage unit is smaller than capacity of the second storage unit.

4. The printing apparatus according to claim 1, wherein
the first storage unit is attachable to and detachable from the carriage.

5. The printing apparatus according to claim 4, wherein
the first storage unit is attachable to and detachable from the carriage together with the first head.

6. The printing apparatus according to claim 4, wherein
the printing apparatus is configured to perform printing operation by the second head using the second ink with the first storage unit detached from the carriage.

7. The printing apparatus according to claim 4, wherein
instead of the first storage unit, a third storage unit configured to store a liquid different from the first ink is attachable to and detachable from the carriage.
